(19) United States
(12) Patent Application Publication
(10) Pub. No.: US 2026/0104128 A1
(43) Pub. Date: Apr. 16, 2026

(54) PADS AND METHODS OF MANUFACTURE AND USE THEREOF

(71) Applicant: DiversiTech Corporation, Duluth, GA (US)

(72) Inventor: Jonathan Sada, Duluth, GA (US)

(21) Appl. No.: 19/355,503

(22) Filed: Oct. 10, 2025

Related U.S. Application Data
(60) Provisional application No. 63/705,805, filed on Oct. 10, 2024.

(51) Int. Cl. F16M 5/00

(52) U.S. Cl. CPC F16M 5/00

(57) ABSTRACT

This disclosure enables a pad which may have a first unit and a second unit.

### CROSS-REFERENCE TO RELATED PATENT APPLICATION

This patent application claims a benefit of priority to U.S. Provisional Patent Application 63/705,805 filed 10 Oct. 2024; which is incorporated by reference herein in its entirety for all purposes.

### TECHNICAL FIELD

This disclosure relates to pads and methods of manufacture and use thereof.

### BACKGROUND

Heating, ventilation, and air conditioning (HVAC) systems, as well as standby electrical generators, are commonly installed outdoors at residential properties. These units require stable support platforms, often referred to as pads, to ensure safe and efficient operation. Industry standards and local building codes typically mandate that such equipment be elevated above the ground surface to prevent exposure to moisture, debris, and seasonal hazards. Installers must address both new installations and retrofits, including situations where existing pads have cracked or settled due to environmental stresses. Achieving reliable elevation and support for these units remains a persistent technical challenge in residential settings.

Outdoor pads for supporting HVAC condensers and standby generators are routinely exposed to a variety of environmental conditions that can compromise their performance. Soil composition, frost heave, seasonal saturation, and differential settlement are among the most significant factors affecting pad stability. Pads placed on soft or disturbed soils are particularly susceptible to uneven sinking, tilting, or shifting, which can lead to equipment misalignment, vibration, and premature wear. Both new installations and retrofits on previously disturbed ground must contend with these risks, especially when the underlying soil is not adequately compacted or when drainage is poor. The need to minimize settlement and maintain consistent elevation is critical for long-term equipment reliability.

Conventional support pads are available in several forms, including single-piece molded plastic pads with internal ribbing, foam-core pads, poured-in-place concrete slabs, lightweight concrete or polymer concrete pads, and composite clad pads. Each of these designs presents distinct limitations when installed on residential sites with challenging soil conditions. Common failure modes may include cracking of the pad material, uneven settling that causes the pad to incline or rock, and structural deformation under load. These issues are exacerbated by environmental factors such as freeze-thaw cycles, water infiltration, and pest intrusion, all of which can accelerate pad deterioration and compromise equipment stability. Installers frequently encounter situations where conventional pads fail to maintain the required elevation above grade, resulting in non-compliance with code requirements and increased maintenance costs.

A recurring technical problem with existing pad designs is their tendency to sink into the ground over time, particularly when supporting heavy equipment such as HVAC condensers or standby electrical generators. Pads with ribbed internal structures may settle unevenly in soft or saturated soils, leading to misalignment and operational inefficiencies. While some pads attempt to address this by increasing footprint size or material thickness, these approaches often result in higher costs, increased weight, and greater difficulty in handling and installation. The challenge is further compounded when retrofitting sites where previous pads have failed, as installers must contend with disturbed or backfilled soils that are prone to additional settlement. Achieving a stable, code-compliant elevation for outdoor equipment remains an unresolved issue in the industry.

In addition to settlement concerns, installers must also consider the need for efficient load transfer, cost-effective manufacturing, and ease of installation. Concrete pads, which feature a flat base resting directly on the ground, are often used to simulate a stable support surface; however, these pads are heavy, expensive, and labor-intensive to produce, ship, and install. Alternative pad designs may incorporate hollow hubs or ribbed structures to reduce weight and material costs, but these features can introduce new failure modes if not properly engineered. The technical problem persists: providing a pad that reliably supports outdoor equipment at the required elevation, minimizes sinking and settlement, and offers a practical solution for both new installations and retrofits, all while meeting industry standards for safety and performance.

### SUMMARY

This disclosure enables a pad that addresses various technical problems mentioned above. The pad may comprise a first unit and a second unit.

In some examples, the first unit includes a container with a first base, a sidewall, and a plurality of ribs, where the sidewall extends away from the first base and encloses the ribs, and the ribs host a plurality of tubular cavities. The second unit includes a second base and a plurality of posts. The pad may be accessed by a user (e.g., a technician) to arrange the first unit and the second unit so that the tubular cavities receive the posts and the first base opposes the second base, and position a condenser or a generator on the first base or the second base.

In some examples, the first unit includes a container having a first base, a sidewall, and a plurality of ribs, where the sidewall extends away from the first base, the plurality of ribs extends from the first base, and the sidewall encloses the plurality of ribs. The plurality of ribs hosts a plurality of tubular cavities. The first base includes a plurality of first base corners. The sidewall includes a plurality of sidewall corners overlapping the plurality of first base corners. The plurality of tubular cavities includes a plurality of corner tubular cavities respectively spaced apart from the plurality of first base corners and the plurality of sidewall corners. The plurality of tubular cavities includes a central tubular cavity. The second unit includes a second base and a plurality of posts. The second base includes a plurality of second base corners. The plurality of posts includes a plurality of corner posts respectively spaced apart from the plurality of second base corners. The plurality of posts includes a central post. The pad may be accessed by a user (e.g., a technician) to arrange the first unit and the second unit such that the plurality of corner tubular cavities receive the plurality of corner posts, the central tubular cavity receives the central post, and the first base opposes the second base and position a condenser or a generator on the first base or the second base.

In some examples, the first unit includes a first base and a sidewall, where the sidewall extends away from the first base. The second unit includes a second base and a plurality of ribs, where the plurality of ribs extends from the second base. The pad may be accessed by a user (e.g., a technician) to arrange the first unit and the second unit such that the sidewall encloses the plurality of ribs and the first base opposes the second base and position a condenser or a generator on the first base or the second base.

### DESCRIPTION OF DRAWINGS

FIG. 1 shows a top perspective view of an example of a pad having a first unit an a second unit according to this disclosure.

FIG. 2 shows a bottom perspective view of an example a pad having a first unit an a second unit according to this disclosure.

FIG. 3 shows a profile view of an example of a pad having a first unit an a second unit according to this disclosure.

FIG. 4 shows a top view of an example of a second unit of a pad according to this disclosure.

FIG. 5 shows a profile view of an example of a second unit of a pad according to this disclosure.

FIG. 6 shows a top view of an example of a corner section of a second unit of a pad according to this disclosure.

FIG. 7 shows a top perspective view of an example of a second unit of a pad according to this disclosure.

FIG. 8 shows a profile view of an example of a corner section of a second unit of a pad according to this disclosure.

FIG. 9 shows a profile view of an example of a center section of a second unit of a pad according to this disclosure.

FIG. 10 shows a top perspective view of an example of an HVAC condenser positioned on a pad according to this disclosure.

FIG. 11 shows a top perspective view of an example of a standby electrical generator positioned on a pad according to this disclosure.

FIG. 12 shows a profile view of an example of a standby electrical generator (or an HVAC condenser) being positioned on a second unit a pad according to this disclosure.

FIG. 13 shows a profile view of an example of a standby electrical generator (or an HVAC condenser) being positioned on a first unit a pad according to this disclosure.

FIG. 14 shows a top view of an example of an underside of a first unit of a pad according to this disclosure.

### DETAILED DESCRIPTION

As explained above, this disclosure enables a pad that addresses various technical problems mentioned above. The pad may comprise a first unit and a second unit.

In some examples, the first unit includes a container with a first base, a sidewall, and a plurality of ribs, where the sidewall extends away from the first base and encloses the ribs, and the ribs host a plurality of tubular cavities. The second unit includes a second base and a plurality of posts. The pad may be accessed by a user (e.g., a technician) to arrange the first unit and the second unit so that the tubular cavities receive the posts and the first base opposes the second base, and position a condenser or a generator on the first base or the second base.

In some examples, the first unit includes a container having a first base, a sidewall, and a plurality of ribs, where the sidewall extends away from the first base, the plurality of ribs extends from the first base, and the sidewall encloses the plurality of ribs. The plurality of ribs hosts a plurality of tubular cavities. The first base includes a plurality of first base corners. The sidewall includes a plurality of sidewall corners overlapping the plurality of first base corners. The plurality of tubular cavities includes a plurality of corner tubular cavities respectively spaced apart from the plurality of first base corners and the plurality of sidewall corners. The plurality of tubular cavities includes a central tubular cavity. The second unit includes a second base and a plurality of posts. The second base includes a plurality of second base corners. The plurality of posts includes a plurality of corner posts respectively spaced apart from the plurality of second base corners. The plurality of posts includes a central post. The pad may be accessed by a user (e.g., a technician) to arrange the first unit and the second unit such that the plurality of corner tubular cavities receive the plurality of corner posts, the central tubular cavity receives the central post, and the first base opposes the second base and position a condenser or a generator on the first base or the second base.

In some examples, the first unit includes a first base and a sidewall, where the sidewall extends away from the first base. The second unit includes a second base and a plurality of ribs, where the plurality of ribs extends from the second base. The pad may be accessed by a user (e.g., a technician) to arrange the first unit and the second unit such that the sidewall encloses the plurality of ribs and the first base opposes the second base and position a condenser or a generator on the first base or the second base.

This disclosure is now described more fully with reference to drawings, in which some examples of this disclosure are shown. This disclosure may, however, be embodied in many different forms and should not be construed as necessarily being limited to various examples disclosed herein. Rather, these examples are provided so that this disclosure is thorough and complete, and fully conveys various concepts of this disclosure to skilled persons. Note that like numbers or similar numbering schemes can refer to like or similar elements throughout.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

Various singular forms “a,” “an” and “the” are intended to include various plural forms (e.g., two, three, four, five, six, seven, eight, nine, ten, tens, hundreds, thousands) as well, unless specific context clearly indicates otherwise.

Various presence verbs “comprises,” “includes” or “comprising,” “including” when used in this specification, specify a presence of stated features, integers, steps, operations, elements, or components, but do not preclude the presence or addition of one or more other features, integers, steps, operations, elements, components, or groups thereof.

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

As used herein, a term “or others,” “combination”, “combinatory,” or “combinations thereof” or another conceptually similar terminology refers to all permutations and combinations of listed items preceding that term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. Skilled persons understand that typically there is no limit on number of items or terms in any combination, unless otherwise contextually apparent.

Unless otherwise defined, all terms (including technical and scientific terms) used herein have the same meaning as commonly understood by one of ordinary skill in an art to which this disclosure belongs. Various terms, such as those defined in commonly used dictionaries, should be interpreted as having a meaning that is consistent with a meaning in a context of a relevant art and should not be interpreted in an idealized or overly formal sense, unless expressly so defined herein.

Relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

As used herein, a term “about” or “substantially” refers to a +/−10% variation from a nominal value/term. Such variation is always included in any given value/term provided herein, whether or not such variation is specifically referred thereto.

Although the terms first, second, can be used herein to describe various elements, components, regions, layers, or sections, these elements, components, regions, layers, or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from various teachings of this disclosure.

Features described with respect to certain example examples can be combined and sub-combined in or with various other example examples. Also, different aspects or elements of example examples, as disclosed herein, can be combined and sub-combined in a similar manner as well. Further, some example examples, whether individually or collectively, can be components of a larger system, wherein other procedures can take precedence over or otherwise modify their application. Additionally, a number of steps can be required before, after, or concurrently with example examples, as disclosed herein. Note that any or all methods or processes, at least as disclosed herein, can be at least partially performed via at least one entity in any manner.

Example examples of this disclosure are described herein with reference to illustrations of idealized examples (and intermediate structures) of this disclosure. As such, variations from various illustrated shapes as a result, for example, of manufacturing techniques or tolerances, are to be expected. Thus, various example examples of this disclosure should not be construed as necessarily limited to various particular shapes of regions illustrated herein, but are to include deviations in shapes that result, for example, from manufacturing.

Any or all elements, as disclosed herein, can be formed from a same, structurally continuous piece, such as being unitary or monolithic, or be separately manufactured or connected, such as being an assembly or modules. Any or all elements, as disclosed herein, can be manufactured via any manufacturing processes, whether additive manufacturing, subtractive manufacturing, or other any other types of manufacturing. For example, some manufacturing processes include three dimensional (3D) printing, laser cutting, computer numerical control routing, milling, pressing, stamping, vacuum forming, hydroforming, injection molding, lithography, chiseling, cutting, and so forth.

Hereby, all issued patents, published patent applications, and non-patent publications that are mentioned or referred to in this specification are herein incorporated by reference in their entirety for all purposes, to a same extent as if each individual issued patent, published patent application, or non-patent publication were specifically and individually indicated to be incorporated by reference. To be even more clear, all incorporations by reference specifically include those incorporated publications as if those specific publications are copied and pasted herein, as if originally included in this disclosure for all purposes of this disclosure. Therefore, any reference to something being disclosed herein includes all subject matter incorporated by reference, as explained above. However, if any disclosures are incorporated herein by reference and such disclosures conflict in part or in whole with this disclosure, then to an extent of the conflict or broader disclosure or broader definition of terms, this disclosure controls. If such disclosures conflict in part or in whole with one another, then to an extent of conflict, the later-dated disclosure controls.

This disclosure describes a pad (100) designed to support at least an item residential outdoor equipment, such as an HVAC condenser (134) or a standby electrical generator (136). The pad (100) includes a first unit (102) and a second unit (104) arranged for cooperative support and alignment during assembly and use. The first unit (102) includes a container (106) having a first base (108) with a first base outer side (108OS) configured for equipment support and a first base inner side (108IS) configured to face the second unit (104). The container (106) further includes a sidewall (110) that depends downward from the first base (108), thereby defining a perimeter that encloses internal structural features. The sidewall (110) encloses a plurality of ribs (112) that extend from the first base inner side (108IS) toward the second unit (104) during assembly. The plurality of ribs (112) hosts a plurality of tubular cavities (114) optionally including a plurality of corner tubular cavities (120), a central tubular cavity (122), and a plurality of non-corner tubular cavities (150). The second unit (104) includes a second base (124) having a second base outer side (104OS) configured to face a ground (158) and a second base inner side (104IS) configured to oppose the first base inner side (108IS). The second unit (104) also presents a plurality of posts (126) including a plurality of corner posts (130) and a central post (132). The plurality of posts (126) is positioned to align with and respectively enter the plurality of tubular cavities (114) during assembly. The pad (100) uses coordinated geometries to align structural features, while maintaining a clear equipment-supporting surface on the first base outer side (108OS).

The first unit (102) serves as a structural container that organizes load paths and provides a direct support platform for the item of residential equipment. The first base outer side (108OS) provides a generally planar contact surface that receives a condenser (134) or a generator (136) after assembly of the pad (100). The first base inner side (108IS) faces the second base inner side (104IS) after assembly, thereby opposing the second unit (104) across a narrow interfacial spacing determined by the heights of the plurality of posts (126) and the depths of the plurality of tubular cavities (114). The sidewall (110) depends from the periphery of the first base (108) and laterally encloses the plurality of ribs (112) to protect structural features and at least partially to guide assembly alignment. The sidewall (110) can present uniform height around the perimeter or present deliberate height variations to tailor stiffness and weight distribution. The plurality of ribs (112) projects away from the first base inner side (108IS) in a pattern that defines multiple wells, channels, and hub regions that collectively host the plurality of tubular cavities (114). The plurality of ribs (112) includes a plurality of hub walls (138) organized into a plurality of corner hub walls (140) positioned near corners and a central hub wall (142) positioned near a planform center. Optionally, the corner hub walls (140) do not internally enclose any walls and therefore present perimeter wall bodies without subordinate internal partitions. The central hub wall (142) encloses the central tubular cavity (122) and may also enclose a plurality of supporting walls (144) that radiate toward the central tubular cavity (122) to establish radial load transfer paths.

The second unit (104) complements the first unit (102) by providing a broad, substantially flat ground interface and a set of upwardly projecting alignment features. The second base outer side (104OS) presents a generally planar surface which contacts the ground (158) that can include soil, compacted aggregate, lawn, pavers, or geotextile-separated subgrade, thereby distributing bearing pressure across supported terrain. The second base inner side (104IS) faces the first base inner side (108IS) after assembly and supports the plurality of posts (126) that align with the plurality of tubular cavities (114). Optionally, the plurality of posts (126) includes the plurality of corner posts (130) extending away from the second base inner side (104IS) in proximity of a plurality of second base corners (128) and the central post (132) positioned near or at a geometric center, with optional additional non-corner posts positioned along span regions if desired. The second base (124) may further include a plurality of corner indents (156) located adjacent to or on the plurality of second base corners (128), where each corner indent (156) provides a shallow recess that receives a corresponding corner rib cluster or wall of the first unit (102) during assembly. The corner indents (156) engage the corner rib clusters or walls in proximity of the corresponding tubular cavities (114) relative to the plurality of posts (126). The second base (124) can be fabricated with consistent thickness or with localized thickening to support posts and corner features without compromising the general flatness of the second base outside side (104OS). The second base (124) and the plurality of posts (126) can be monolithic with each other, with assembled posts as alternatives. The second base outside side (104OS) remains continuous to maintain a broad area of contact with the ground (158) while permitting surface texture that does not materially affect functional flatness.

The plurality of tubular cavities (114) hosted by the first unit (102) cooperates with the plurality of posts (126) to guide assembly and to resist relative movement after assembly. The plurality of corner tubular cavities (120) reside near (e.g., within three inches or less) corresponding first base corners (116) and sidewall corners (118), where each corner tubular cavity (120) offsets inward from a respective corner to optionally clear the corner hub walls (140). The central tubular cavity (122) resides within the central hub wall (142) and accepts the central post (132) during assembly, thereby establishing a central datum for the pad (100). Optional non-corner tubular cavities (150) may respectively terminate a plurality of connecting walls (148) that radiate outward from the central hub wall (142) to extend in non-corner directions without contacting the corner hub walls (140). A plurality of terminating walls (152) may span between the plurality non-corner tubular cavities (150) and the sidewall (110) to complete structural pathways toward edges. The plurality of posts (126) employs shapes and dimensions coordinated with shapes and dimensions of the plurality of tubular cavities (114) to establish suitable interference, clearance, or snap engagements as desired for retention. The plurality of posts (126) may include slight tapers and chamfers that promote guided insertion without binding during assembly maneuvers. The plurality of tubular cavities (114) may include lead-in chamfers coordinated with post features to further improve guided assembly and to reduce the likelihood of misalignment. The plurality of posts (126) and the plurality of tubular cavities (114) can be circular, but polygonal or keyed in alternatives are possible to resist unwanted rotation after assembly. Cooperative geometry across these features supports reliable assembly sequences and robust positional stability under service loads.

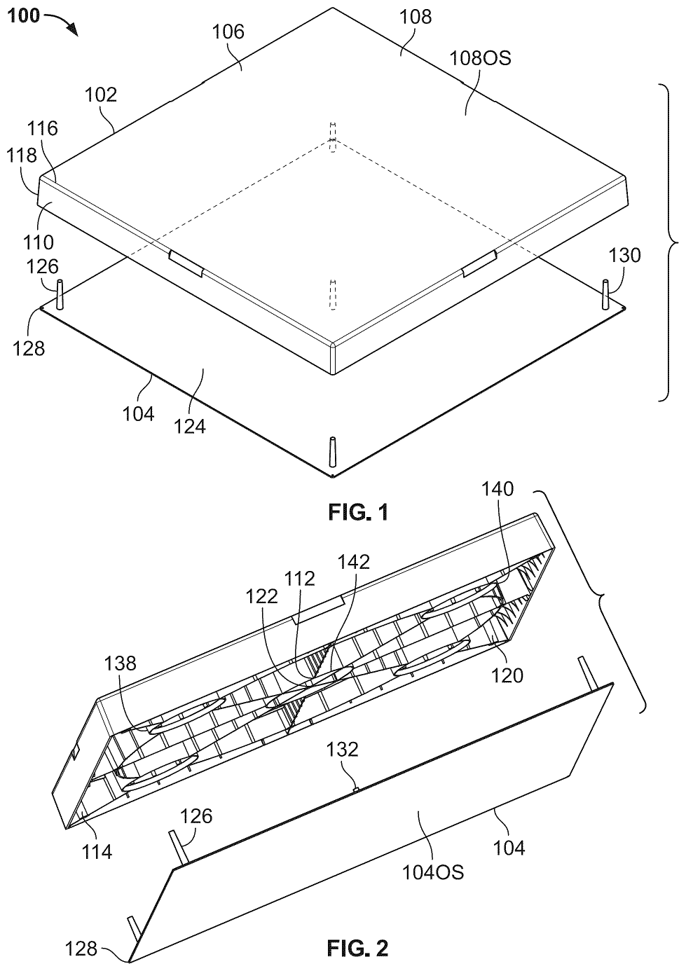

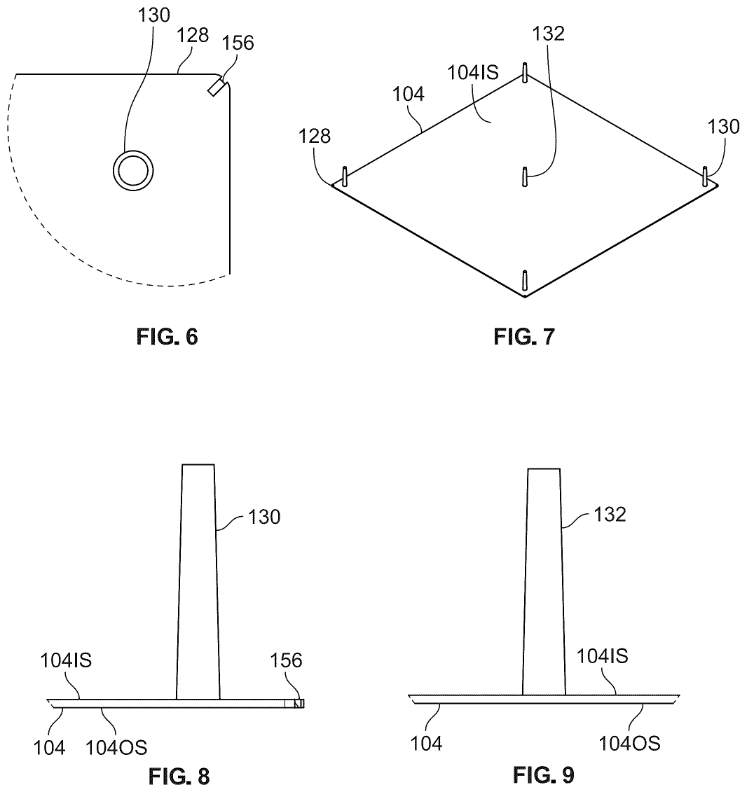

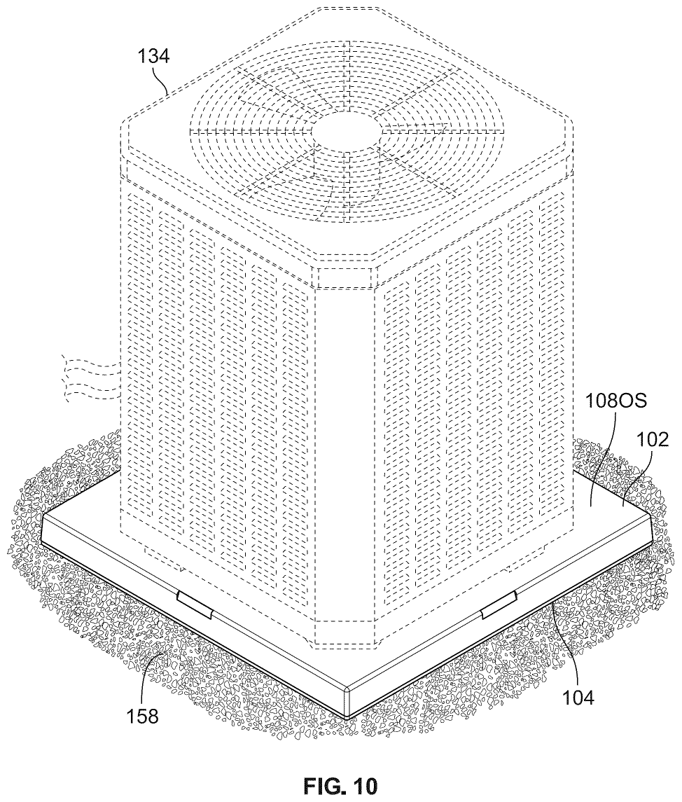

FIG. 1 presents an unassembled, exploded-style top perspective view that introduces the principal relationships between pad components with visually intuitive separation. The first unit (102) appears above the second unit (104) to reveal relative planform shapes and the positional relationships between the plurality of tubular cavities (114) and the plurality of posts (126). The first base outer side (108OS) faces the viewer in FIG. 1, thereby highlighting the equipment-supporting surface that will receive a condenser (134) or a generator (136) after assembly, as shown in FIGS. 10-13. The sidewall (110) depends downward from the first base (108) in FIG. 1, forming a skirt boundary that outlines the protected interior where the plurality of ribs (112) resides. The second unit (104) appears below the first unit (102) with the second base inner side (104IS) facing upward and the second base outside side (104OS) facing downward. The plurality of posts (126) protrudes upward from the second base inner side (104IS), demonstrating alignment paths toward the plurality of tubular cavities (114) located within the first unit (102). As shown in FIGS. 6-8, the corner indents (156) appear at corners of the second base (124) and reveal shallow recesses that will later receive corner rib clusters of the first unit (102). The label (154) appears on the sidewall (110) in FIG. 1 as a visible panel or molded legend indicating pad size or model information. The exploded presentation in FIG. 1 allows a viewer to appreciate component functions before any interlocking engagements occur during the assembly sequence. The spatial separation in FIG. 1 therefore clarifies major components and prepares the viewer for deeper geometric descriptions presented in later paragraphs.

FIG. 2 presents an unassembled, exploded-style bottom perspective view that exposes structural features otherwise hidden during normal use. The first unit (102) appears above the second unit (104) with the first base inner side (108IS) facing the viewer, thereby revealing the plurality of ribs (112) and the plurality of tubular cavities (114) hosted by the rib network. The corner tubular cavities (120) and the central tubular cavity (122) appear at locations spaced apart from corresponding corner hub walls (140) and the central hub wall (142), respectively. The plurality of ribs (112) shows continuous wall segments that connect hub structures to perimeter regions and to other structural features, as further described below. The second unit (104) appears below with the second base inner side (104IS) not facing the viewer, thereby displaying the plurality of posts (126) including corner posts (130) and the central post (132). The second base outside side (104OS) faces the viewer in FIG. 2, indicating the orientation that will ultimately contact the ground (158) during service. As shown in FIGS. 6-8, the corner indents (156) appear at the corners of the second base (124) as shallow recesses that promote pre-alignment with the first unit's 102 corner rib clusters along the expected assembly paths. The exploded separation in FIG. 2 permits a detailed understanding of how the plurality of posts (126) will engage the plurality of tubular cavities (114) during assembly by highlighting alignment axes. The bottom perspective view therefore complements the top perspective view of FIG. 1 and collectively establishes a complete orientation framework. The combination of FIG. 1 and FIG. 2 firmly establishes the cooperative roles of both units before assembly. In some situations, the second unit (104) hosts the plurality of ribs (112), whether with or without the plurality of posts (126). As such, and the first unit (102) may cover or enclose the plurality of ribs (112) and the plurality of posts (126) if present, whether the plurality of ribs (112), or the plurality of posts (126) if present, is exposed to natural elements (e.g., without the sidewall (110)) or protected from natural elements (e.g., via the sidewall (110)). For example, the sidewall (110) may contact or engage the plurality of ribs (112) to minimize lateral movement of the first unit (102) or the second unit (104) relative to each other.

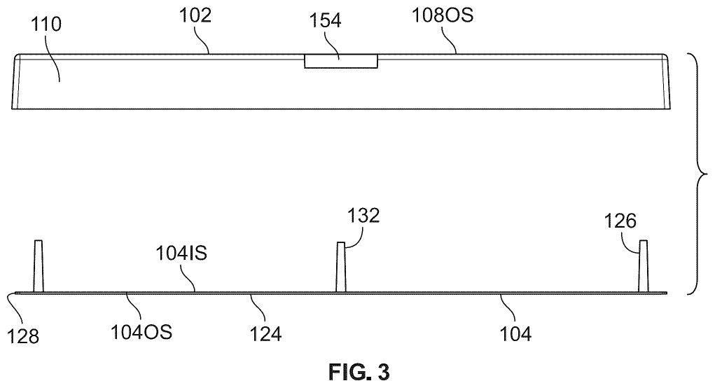

FIG. 3 presents an unassembled profile view that clarifies vertical relationships and dimensional envelopes prior to assembly. The first unit (102) appears above and shows the first base outer side (108OS) as an equipment-supporting surface and the sidewall (110) depending downward as a protective skirt. The first base inner side (108IS) faces downward in FIG. 3, where the plurality of ribs (112) and the plurality of tubular cavities (114) would reside behind the profile outline. The second unit (104) appears below and displays the second base inner side (104IS) facing upward, along with the plurality of posts (126) projecting upward from the second base (124). The second base outer side (104OS) faces downward in FIG. 3, emphasizing the future ground-contacting plane that will rest on the ground (158) during service. The separation distance between units in FIG. 3 allows the viewer to visualize the depth relationships for posts, cavities, and dependent sidewall sections. The profile view also helps the viewer understand the height options for the pad (100), where representative overall assembled pad heights can include about one inch, about two inches, or about three inches, for example. Representative heights not specifically listed remain within the contemplated ranges to accommodate different equipment footprints and installation preferences.

The plurality of posts (126) and the plurality of tubular cavities (114) align through coordinated planform and elevation geometry that the figures present from multiple angles. The second unit (104) may include exactly five posts, with four corner posts (130) near the corners and one central post (132) at or near the geometric center. The first unit (102) may include corner tubular cavities (120) offset inward from corresponding first base corners (116) and sidewall corners (118) and a central tubular cavity (122) aligned with the central post (132). Optional non-corner posts (126) can be added along edges or along internal spans in alternative embodiments that benefit from additional interlocks or anti-rotation features. Optional non-corner tubular cavities (150) can be positioned within the plurality of ribs (112) in locations that terminate connecting walls (148) before those connecting walls reach the sidewall (110). Some use cases may employ circular cross-sections for posts and cavities to simplify molding and assembly, with polygonal, oval, or keyed alternatives described for enhanced orientation control. The plurality of posts (126) may optionally include slight taper angles that narrow away from the second base inner side (104IS) to guide insertion and to enable consistent manufacturing release from molds. The plurality of tubular cavities (114) may include lead-in chamfers or shallow radii that receive matching or complementary features on the plurality of posts (126). The alignment strategy supports repeatable assembly, robust interlock retention, and predictable load transfer between units. The planned distribution of posts and cavities therefore balances manufacturing efficiency with structural performance without limiting broader alternatives.

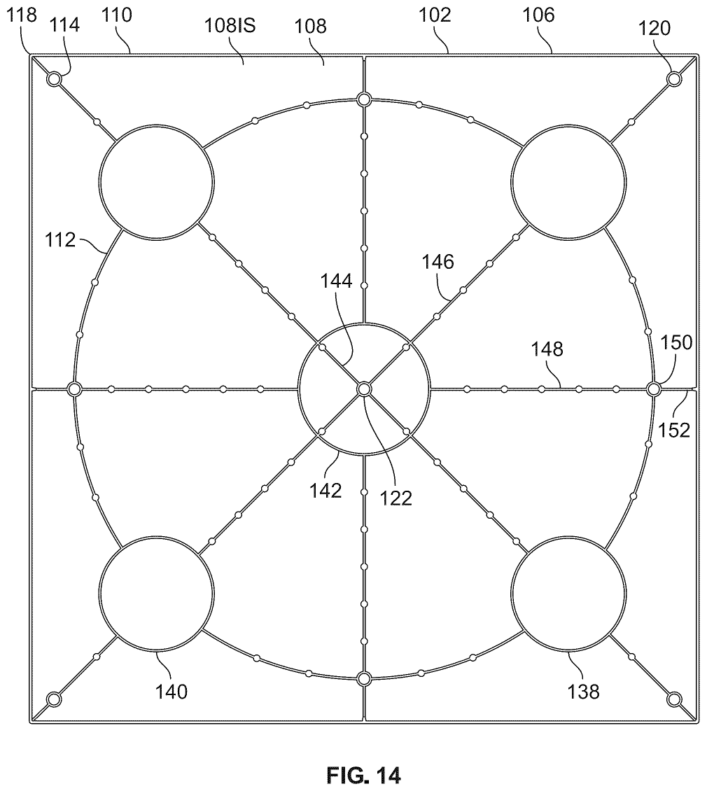

The plurality of ribs (112) within the first unit (102) provides a clear hierarchy of wall types. The plurality of hub walls (138) include the plurality of corner hub walls (140) and the central hub wall (142) arranged to define primary structural nodes. Each corner hub wall (140) exists as a wall body that does not internally enclose any subordinate walls, thereby forming an open ring or arc segment around associated corner regions. The central hub wall (142) forms a wall enclosure around the central tubular cavity (122) and may also enclose the plurality of supporting walls (144) that radiate toward the central tubular cavity (122) to stiffen the central region. The plurality of connecting walls (146) can radiate from the central hub wall (142) and respectively extend toward the plurality corner hub walls (140) to create directed pathways for load flow while maintaining clear spatial relationships. The plurality of connecting walls (148) can extend across and span between the non-corner tubular cavities (150) and the central hub wall (142), thereby avoiding direct contact with any corner hub wall (140). Each connecting wall (148) can terminate at a non-corner tubular cavity (150) and extends between two corner regions or respective corner hub walls (140), as shown in FIG. 14, thereby defining a structural node that remains independent from adjacent corner hub walls. Terminating walls (152) can span between the non-corner tubular cavities (150) and the sidewall (110), thereby completing structural grids that reach the perimeter. The described hierarchy allows the viewer to understand how the corner regions remain open internally or without the corner hub walls (140) respectively enclosing any walls, while the center region or the central hub wall (142) retains enclosed support architecture.

Post-shaped fillets may appear at selected junctions along the plurality of ribs (112) to provide localized reinforcement and to moderate stress concentrations. Each post-shaped fillet can present a cross-section that relates visually to the plurality of posts (126), with either matching diameter or reduced diameter depending on desired visual distinction. Designers may place post-shaped fillets at intersections between connecting walls (146) and the central hub wall (142) to stiffen critical junctions subject to radial loading from supported equipment. Additional post-shaped fillets may appear along mid-spans of connecting walls (148) where bending stresses concentrate between corner regions. Post-shaped fillets can also appear near the terminating walls (152) where rib networks meet perimeter regions adjacent the sidewall (110), thereby moderating transitions into thicker perimeter material. Each post-shaped fillet can be solid through thickness or shell-type with coring features that conserve material while preserving stiffness and moldability. The distribution of post-shaped fillets can be uniform for visual rhythm or varied to tailor local stiffness where analysis indicates higher demands. The post-shaped fillet strategy supports the goal of predictable stiffness without compromising compatibility with the plurality of tubular cavities (114) and the plurality of posts (126). The figures may not depict every optional fillet, yet the description ensures the viewer understands viable placements and functional intentions. The described fillet concept integrates seamlessly with the presented hub and wall hierarchy and therefore remains consistent across embodiments.

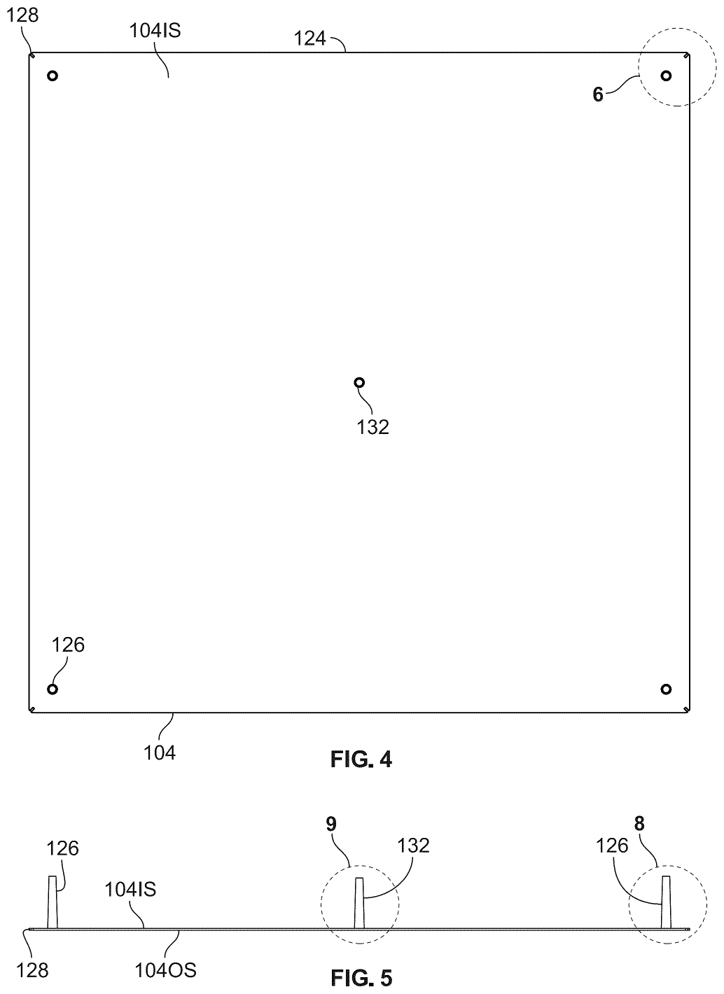

FIG. 4 presents a top view of the second unit (104) that highlights planform layout and positional relationships for alignment features. The second base (124) defines rectangular geometry, while the description supports additional shapes including trapezoids, polygons, circles, and curved outlines. As shown in FIG. 1, the corner posts (130) appear to be spaced apart from the second base corners (128) to avoid thin edge conditions and to align with the corner tubular cavities (120) hosted within the first unit (102). The central post (132) appears near the planform center to index the first unit (102) centrally during assembly and to assist in resisting rotation during service. Optional non-corner posts (126) may appear along spans between or in spaced apart proximity of corners to provide additional interlocks where rib networks include non-corner tubular cavities (150). As shown in FIGS. 6-8, the corner indents (156) appear at the corners as shallow planform recesses that engage respective corner rib clusters before those clusters bring corner tubular cavities (120) into alignment with the corner posts (130). The orientation of FIG. 4 emphasizes that the second base outside side (104OS) remains functionally flat on the opposite face for the ground (158) contact, thereby allowing the viewer to infer the continuous support presented to ground (158) during use. The second base (124) may include subtle surface textures on the second base inner side (104IS) for aesthetics and friction while preserving the functional planarity on the second base outside side (104OS). The second unit (104) can include rounded or chamfered perimeter edges that facilitate handling without compromising alignment functions. The plan view therefore communicates spatial logic for later engagement with the first unit (102).

FIG. 5 presents a profile view of the second unit (104) that communicates thickness, projection heights, and potential molding draft angles. The profile shows the second base inner side (104IS) and the second base outside side (104OS) with a thickness that suits injection molding practices while supporting structural duties. The plurality of posts (126) projects upward from the second base inner side (104IS), thereby defining insertion lengths that cooperate with depths of the plurality of tubular cavities (114). The profile view supports optional taper on the plurality of posts (126), where each post narrows away from the second base inner side (104IS) to assist lead-in alignment and manufacturing release. The profile view can show representative vertical offsets that reflect assembled pad (100) heights of about one inch, about two inches, or about three inches, for example, with other values remaining possible. The profile can also suggest thicker post bases or local bosses around the plurality of posts (126) to manage stresses at post roots during assembly forces. The profile can incorporate subtle perimeter bevels along edges of the second base (124) that improve handling comfort without diminishing ground contact. The profile may depict draft angles on the posts (126) and on perimeter features to reflect realistic molding practices without binding interpretations to specific numeric angles. The profile presentation therefore conveys a balanced combination of manufacturability and functional geometry.

FIG. 6 presents a top view of a corner section of the second unit (104) that isolates corner alignment features for clarity. The corner post (130) resides inward from the second base corner (128) to establish favorable material thickness around the post root and to align with the first unit's (102) corner tubular cavity (120). The corner indent (156) appears as a shallow recess located along the perimeter at the corner region and positioned to receive a corresponding corner rib cluster during assembly approach. The corner indent (156) lies opposite the corner tubular cavity (120) along the expected assembly path. The corner indent (156) assists lateral pre-alignment, reduces the chance of corner rib collision with post features, and guides the corner rib cluster toward precise engagement between the corner tubular cavity (120) and the corner post (130). The corner section may present subtle reliefs or fillets that ease sliding contact between the corner indent (156) surfaces and the corner rib cluster surfaces during assembly maneuvers. The corner section may also include small chamfers at the corner post (130) leading edge to cooperate with a chamfer at the corner tubular cavity (120) leading edge. The corner section can incorporate material transitions that distribute loads from the corner post (130) into the second base (124) without creating stress risers at corners. The corner section further confirms that the second base outside side (104OS) remains continuous and functionally flat for engagement with ground (158). The described geometry improves user confidence during assembly without restricting broader alternatives for corner designs.

FIG. 7 presents a top perspective view of the second unit (104) that communicates three-dimensional relationships among posts, corners, and perimeter features. The perspective view displays the corner posts (130), the central post (132), and any optional non-corner posts (126) projecting upward from the second base inner side (104IS), as also shown in FIG. 1. The corner indents (156) appear at each corner as shallow recesses that collectively form a visual pattern consistent with pre-alignment objectives, as shown in FIG. 6. The second base (124) perimeter may include gentle corner radii or chamfers that improve handling while preserving planform fidelity for mating with the first unit (102). The second base inner side (104IS) may include aesthetic textures or shallow recess patterns that do not affect functional ground contact on the second base outside side (104OS). The perspective view highlights the relative heights of the plurality of posts (126) and suggests coordinated depths within the plurality of tubular cavities (114). The perspective view also confirms that the plurality of posts (126) can be monolithic with the second base (124), although assembled (e.g., fastened, mated) posts remain permissible alternatives in certain situations. The perspective view may include visual cues of draft angles that assist removal from molds. The perspective view encourages the viewer to visualize how the second unit (104) approaches the first unit (102) during the assembly sequence.

FIG. 8 presents a profile view of a corner section of the second unit (104) that emphasizes vertical geometry at a perimeter region. The corner post (130) projects upward from the second base inner side (104IS) and demonstrates a root region that may include local thickening to handle assembly loads. The profile view shows how the corner indent (156) forms a shallow recess adjacent the perimeter and above or within the second base outside side (104OS), thereby preserving functional ground contact. The corner indent (156) may include a gentle slope or rounded interior edges that enable a corner rib cluster to settle into the recess with minimal resistance. The profile view can show draft angles on the corner indent (156) walls to reflect practical molding constraints and to avoid scuffing during part ejection. The profile can suggest a relationship where the corner post (130) stands by a height coordinated with a depth range of the corner tubular cavity (120), thereby promoting controlled insertion depth. The profile can include a small chamfer on the corner post (130) to cooperate with a complementary chamfer on the corner tubular cavity (120) for guided mating. The perimeter edge of the second base (124) remains continuous beneath the corner indent (156) so that the second base outside side (104OS) maintains an uninterrupted ground (158) contact plane. The described geometry assures the viewer that pre-alignment features do not compromise load distribution during service. The corner section profile therefore integrates alignment logic with structural ground-bearing integrity.

FIG. 9 presents a profile view of a center section of the second unit (104) that emphasizes central alignment and load distribution. The central post (132) projects upward from the second base inner side (104IS) at or near a geometric center to provide a central datum for the first unit (102) during insertion. The central post (132) may include a slight taper to assist centering as the central tubular cavity (122) descends during the assembly sequence. The second base outside side (104OS) remains substantially flat across the center section to maintain uniform ground contact with ground (158) during service. The center section profile may include internal ribbing or thickened zones that improve stiffness without disrupting the external flatness of the second base outside side (104OS). The profile may also include subtle perimeter bevels that reduce sharpness while preserving dimensional control of the center region. The center section can include radiused transitions between thickened zones and thinner web regions to moderate stress concentrations during equipment loading and thermal cycling. The profile supports a wide range of material choices including UV-stabilized thermoplastics that suit injection molding processes. The profile implicitly coordinates with the depth of the central tubular cavity (122) to produce desired insertion depths and retention characteristics. The profile therefore establishes a robust central engagement that complements corner engagements for comprehensive positional stability.

FIG. 10 presents a top perspective view that illustrates a representative HVAC condenser (134) shown in broken lines positioned on the assembled pad (100) for environmental context. The condenser (134) rests on the first base outer side (108OS) of the first unit (102), thereby demonstrating equipment placement without adding limiting callouts or hidden-line details. For example, the HVAC condenser (134) the condenser may weigh 700 pounds or under (e.g., 600, 500, 400, 300, 200 or less). The first unit (102) rests upon the second unit (104), and the second base outside side (104OS) engages the ground (158) to distribute bearing forces. The broken-line depiction emphasizes that the condenser (134) representation serves as an example and does not limit pad dimensions, equipment models, or equipment footprints. The perspective presentation allows the viewer to appreciate relative scale between the condenser (134) and the pad (100) across a typical residential installation scenario. The perspective view maintains visibility of sidewall features including the label (154) hosted on the sidewall (110), thereby reinforcing identification during installation or service, as also shown in FIG. 3. The perspective presentation maintains clarity regarding the orientation of the first base outer side (108OS) as the primary equipment-supporting surface for the majority of residential use cases. The perspective presentation remains consistent with the assembly relationships developed in earlier figures while focusing on final placement for contextual understanding. The perspective view does not imply any mandatory fastener locations or anchorage hardware and therefore preserves broad compatibility. The figure therefore conveys an intuitive visual of the assembled pad (100) supporting the condenser (134).

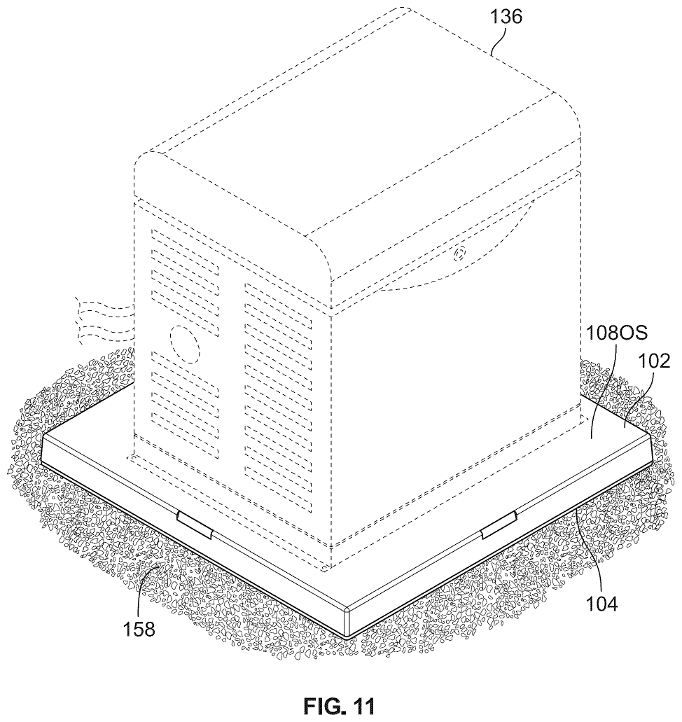

FIG. 11 presents a top perspective view that illustrates a representative electrical generator (136) shown in broken lines positioned on the assembled pad (100) for contextual clarity. The generator (136) rests on the first base outside side (108OS) of the first unit (102), thereby confirming compatibility with generator skids that require stable, planar contact. For example, the electrical generator (136) the condenser may weigh 700 pounds or under (e.g., 600, 500, 400, 300, 200 or less). The first unit (102) rests on the second unit (104), and the second base outer side (104OS) engages the ground (158) to maintain a broad bearing surface. The broken-line representation indicates that generator dimensions, mounting patterns, and clearances remain illustrative and non-limiting. The perspective orientation helps readers visualize typical residential placement adjacent a dwelling, fence, or landscape feature without implying any site-specific constraints. The perspective view maintains the same orientation definitions used for FIG. 10, thereby reinforcing consistent terminology for equipment-supporting and ground-engaging sides. The perspective view again presents the label (154) placement on the sidewall (110), which assists identification for multiple size families within a product line. The perspective view avoids fastener or conduit specifics to keep the description focused on the pad (100) structure and equipment placement. The perspective view therefore complements FIG. 10 by confirming pad compatibility with another common residential equipment category. The figure demonstrates that the pad (100) supports equipment across a wide range of residential applications.

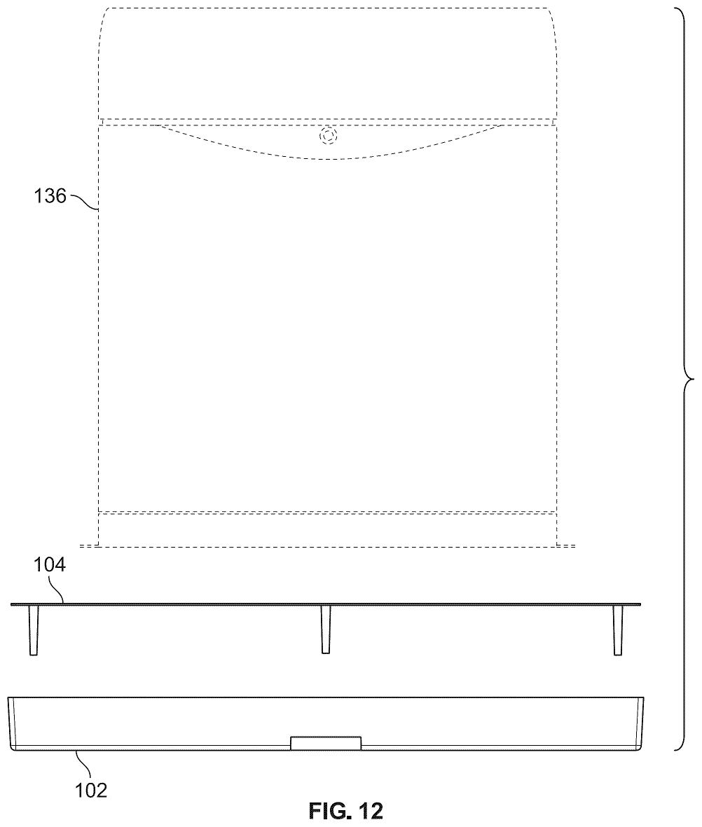

FIG. 12 presents a profile view that illustrates a representative assembly and handling sequence where the second unit (104) inserts into the first unit (102) while the first unit (102) has its rib network facing skyward. The installer places the first unit (102) with the first base inner side (108IS) facing upward, thereby exposing the plurality of tubular cavities (114) and the corner rib clusters for guided alignment. The installer then lowers the second unit (104) with the second base inner side (104IS) facing downward toward the first base inner side (108IS) so that the plurality of posts (126) approaches the plurality of tubular cavities (114). The corner indents (156) encounter corresponding corner rib clusters before location of corner tubular cavities (120) relative to corner posts (130), thereby providing positional pre-or co-alignment. Continued lowering causes the corner posts (130) and the central post (132) to enter the corner tubular cavities (120) and the central tubular cavity (122), respectively, with optional guidance from chamfers and tapers. After the second unit (104) fully inserts into the first unit (102), the installer flips the assembled pad (100) so that the second base outside side (104OS) faces downward to contact the ground (158). The installer can temporarily or permanently position a representative condenser (134) or a representative generator (136) on the second base (124) during staging, as FIG. 12 indicates for situational clarity. The profile view clarifies that the temporary or permanent placement on the second base (124) occurs during handling and does not restrict final placement options. The description emphasizes that other assembly sequences remain possible while preserving the confirmed visualizable sequence for primary embodiments. The profile view therefore records a practical method of engaging posts (126) and cavities (114) without requiring visibility of the underside during insertion.

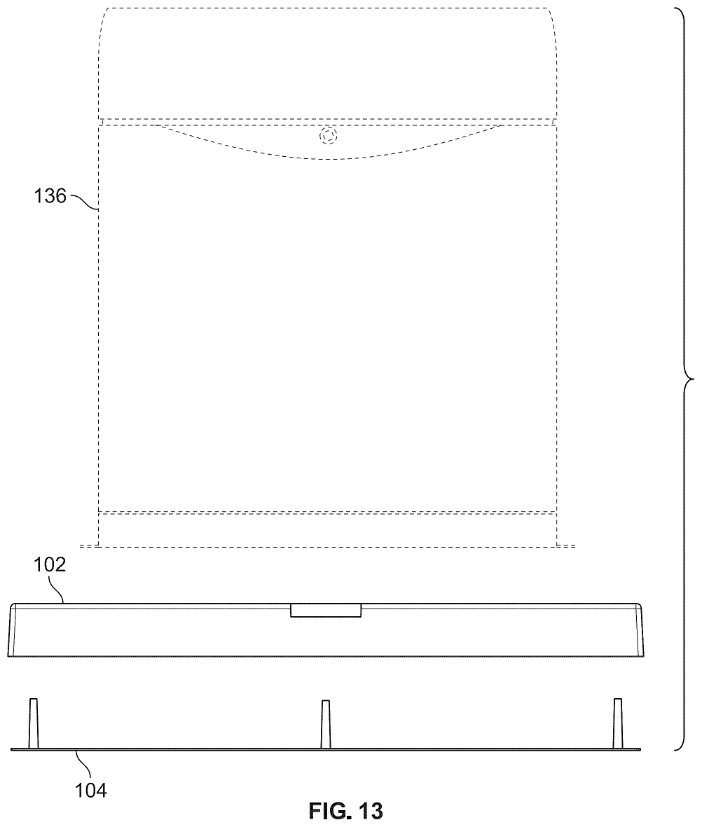

FIG. 13 presents a profile view where the installer positions a representative generator (136) or a representative condenser (134) on the first base outside side (108OS) after flipping the assembled pad (100) onto the ground (158). The second base outside side (104OS) now rests on the ground (158), thereby simulating the broad contact associated with a flat side of a conventional concrete pad. The first base inner side (108IS) opposes the second base inner side (104IS), and the plurality of posts (126) remain engaged with the plurality of tubular cavities (114) after the flipping step. The sidewall (110) depends downward from the first base (108) and now surrounds the second unit (104) along the perimeter, thereby shielding interfacial regions from debris. The installer aligns equipment feet or skids on the first base outside side (108OS) using conventional placement practices suited to residential installations. The profile view confirms that the first base outside side (108OS) serves as the primary equipment-supporting plane for preferred embodiments, while remaining consistent equipment placement on either base (first 108 or second 124). The described sequence emphasizes reliable engagement between posts (126) and cavities (114) that persists after flipping and final positioning. The profile view focuses on structural relationships and does not imply fastening details or conduit routing features. The profile summarizes final orientation and provides a visualizable end state for the pad supporting equipment.

FIG. 14 presents a top view of the underside of the first unit (102) that reveals the complete rib and hub architecture in plan. The plurality of ribs (112) extends from and away the first base inner side (108IS) and forms a network of walls that define wells, channels, and hubs. The hub walls (138) include four corner hub walls (140), where each corner hub wall (140) does not internally enclose any walls and therefore remains open within the perimeter it outlines. The central hub wall (142) encloses the central tubular cavity (122) and may enclose supporting walls (144) that radiate toward and respectively span between the central tubular cavity (122) and the central hub wall (142) to reinforce the central region. Connecting walls (146) extend from the central hub wall (142) toward corner hub walls (140) to establish radial pathways that stiffen spans between the center and corners. Connecting walls (148) extend across spans that lie between corner regions or corner hub walls (140) while contacting the central hub wall (142), thereby avoiding contact with any corner hub wall (140). Each connecting wall (148) can terminate at a non-corner tubular cavity (150) extending between corner regions or the corner hub walls (14) and separated from the corner hub walls (140). Terminating walls (152) extend from each non-corner tubular cavity (150) to the sidewall (110), thereby completing structural links to the perimeter. Post-shaped fillets may appear at selected junctions along connecting walls (146), connecting walls (148), and terminating walls (152) to strengthen load paths without obstructing any tubular cavity entries. The plan view therefore exposes a coherent structural network that hosts cavities and supports reliable engagement with posts.

The sidewall (110) provides additional features that enhance identification, handling, and optional functionality while maintaining clear structural roles. As shown in FIG. 3, the label (154) appears on the sidewall (110) as a region that presents pad size information or model identifiers using molded-in raised characters, molded-in recessed characters, or adhered label media. The label (154) region can occupy a shallow rectangular depression that frames text or images for legibility while preserving sidewall thickness around the depression for strength. The sidewall (110) may present uniform height to create a consistent skirt depth around the first base (108), or the sidewall (110) may present varying height segments that reduce weight while maintaining stiffness near critical locations. The sidewall (110) may include interior gussets at corners that reinforce transitions between perimeter regions and adjacent rib clusters without blocking access to the plurality of tubular cavities (114). The sidewall (110) may include micro-texture that resists scuffing and visually harmonizes with texture on the first base outside side (108OS). The sidewall (110) may incorporate subtle handhold recesses on larger sizes to improve handling during transport and placement, while avoiding excessive removal of material that could compromise stiffness. The sidewall (110) may cooperate with the corner indents (156) by presenting complementary shapes on internal corners that glide into corner recesses during the insertion portion of the assembly sequence. The sidewall (110) thereby contributes to correct alignment while protecting the interior rib network from external impacts during handling. This collection of features demonstrates how perimeter geometry supports function and identification without limiting alternative sidewall presentations.

There may be a wide range of planform shapes and corner counts while presenting a primary rectangular embodiment for clarity. The first base (108), the sidewall (110), and the second base (124) may collectively define a rectangle having four corners for the primary shown configuration. The description also permits alternative shapes including squares, trapezoids, pentagons, hexagons, octagons, circular outlines, and asymmetric profiles for specialized footprints. The plurality of first base corners (116), the plurality of sidewall corners (118), and the plurality of second base corners (128) may be four or fewer in some embodiments, or more than four in other embodiments, depending on planform geometry. The corner tubular cavities (120) remain positioned inward from the first base corners (116) and the sidewall corners (118) to respect corner hub placement and wall thickness targets. The pad (100) suits nominal residential sizes including about 24×24 inches, about 30×30 inches, and about 36×36 inches for condenser use cases, for example. The pad (100) may also suits nominal generator sizes including about 36×48 inches and about 42×60 inches, with additional sizes supported for larger or smaller equipment footprints. The described size families remain illustrative and non-limiting, allowing expansion to accommodate different regional preferences or manufacturer specifications. Note that the corner features and cavity distributions scale proportionally across size families as needed to maintain alignment and stiffness.

Material selections and manufacturing practices support robust structures while enabling economical production across size families. The first unit (102) and the second unit (104) may be injection molded from UV-stabilized high-density polyethylene or polypropylene for durability and outdoor weathering resistance. The pad (100) may also be formed from recycled content, glass-filled formulations, and hybrid constructions when additional stiffness or environmental objectives require enhanced materials. The pad (100) may also be formed from polymer concrete or metal alternatives for specialized applications while maintaining compatibility with the described post-and-cavity alignment strategies. The injection molding process may employ solid molding or structural foam molding for thicker sections where weight and sink control benefit from foam cores. Draft angles on ribs, posts, and sidewalls assist part ejection and reduce scuffing, where representative draft values can be selected according to tool design without binding the description to specific degree numbers. Gate placement and vent strategies may balance flow toward the central hub wall (142) and corner regions to reduce knit-line weaknesses and to promote uniform material distribution. Rib-to-wall thickness ratios may follow general molding guidance to manage sink while preserving stiffness across rib intersections and hub regions. Coring features may appear within thicker walls to reduce sink while maintaining structural objectives and to conserve material. The described practices provide a manufacturable framework applicable to production across multiple pad sizes and geometries.

The second base outer side (104OS) plays a clear role as a ground-engaging surface that simulates a flat concrete contact face without imposing concrete handling burdens. The second base outer side (104OS) can incorporate shallow micro-texture for slip resistance during handling while maintaining functional flatness that distributes bearing pressures across the ground (158). The ground (158) may include compacted soil, compacted aggregate, lawn, paver beds, or geotextile-separated bases, where the described flatness accommodates a broad range of site conditions. The second base outer side (104OS) may include radiused perimeter transitions that reduce edge gouging of soft subgrades while maintaining contact continuity. The second base outer side (104OS) may be cleaned easily during installation and service due to the absence of deep tread patterns or cavities on the ground-contacting face. The described flat interface supports frost-susceptible regions by distributing loads across broader areas, thereby moderating localized bearing pressures under seasonal changes. The described interface also supports retrofits by providing a consistent bearing surface even where previous pads left uneven impressions in underlying soils. The second base outer side (104OS) therefore serves as a functional analog to a conventional concrete pad face while preserving the handling advantages associated with polymeric components. The described role remains compatible with a wide range of installations without restricting ground preparation practices. The described role contributes to predictable performance across varied residential environments.

The plurality of posts (126) and the plurality of tubular cavities (114) may employ multiple retention strategies that can be selected according to installation requirements. A friction or interference fit can provide primary retention where manufacturing tolerances yield controlled insertion forces during assembly. Adhesive bonding may be applied at contact regions between the plurality of posts (126) and the plurality of tubular cavities (114) where installers desire permanent assemblies. Mechanical snap features may be included at post shoulders or cavity entrances to produce audible and tactile feedback during full engagement. Quarter-turn bayonet features may be integrated for applications requiring rapid engagement and controlled disengagement under maintenance scenarios. Set screws or through-bolts may be applied across selected post-cavity pairs where uplift resistance or theft deterrence necessitates positive mechanical locking. Combinations of retention strategies may be used on the same pad to fine-tune resistance against different load vectors at central and corner locations. The described options do not limit simpler assemblies where geometry alone accomplishes required positional stability. The described options preserve compatibility with the assembly sequence where the second unit (104) inserts into the first unit (102) during the skyward configuration. The described options therefore enable tailoring without constraining basic assembly logic.

Drainage and environmental management features can be incorporated without compromising ground contact or assembly guidance. The plurality of ribs (112) can include small weep apertures located at low points near the terminating walls (152) so incidental moisture can exit the interior region enclosed by the sidewall (110). The central hub wall (142) may include discrete apertures or channels that allow incidental moisture to pass from central wells toward perimeter regions without collecting near the central tubular cavity (122). The sidewall (110) may include minor reliefs near the base edge to prevent water trapping along the perimeter when the pad (100) rests on wet ground or paved surfaces. The first base outer side (108OS) may incorporate fine surface textures that provide traction without collecting standing water around equipment feet or skids. The second base outer side (104OS) should remain continuous and functionally flat, so the pad (100) locates drains away from the ground-contacting face to preserve full bearing support. The described drainage paths may be optional for arid regions and more prominent for regions with seasonal saturation or freeze-thaw cycles. The described drainage features remain small and non-obtrusive so installers can handle the pad without snagging or unintended water channeling onto adjacent structures. The described features complement the structural hierarchy without interrupting the primary post-and-cavity alignment logic. The described drainage approach thereby supports environmental robustness across varied climates.

As shown in FIG. 3, the label (154) provides installation-relevant information without interfering with structure or assembly. The label (154) may present pad dimensions, model identifiers, manufacturing dates, or batch codes that assist warehousing, selection, and warranty recordkeeping. The label (154) may be molded as raised characters for durability, molded as recessed characters for paint-fill options, or applied as an industrial adhesive label where post-molding customization is advantageous. The label (154) may reside within a shallow label panel recessed into the sidewall (110) to protect edges from abrasion during handling. The label (154) may be positioned at one sidewall face for small sizes or at multiple sidewall faces for larger sizes to improve visibility from different installation approaches. The label (154) can be aligned with a first base corner (116) reference to provide a consistent orientation cue for installers who must align equipment feet with site constraints. The label (154) may include maintenance reminders advising installers to check local codes for minimum elevation requirements before final placement. The label (154) may include a Quick Response (QR) code that links to digital installation guides while avoiding any structural or geometric commitments within the physical product. The label (154) maintains visual coherence with sidewall textures and draft angles used across the sidewall (110). The described communication features promote efficient installation and service without constraining structural design freedom.

Size families and height options address common residential footprints while preserving broad flexibility for future equipment designs. The description supports nominal condenser pads sized about 24×24 inches, about 30×30 inches, and about 36×36 inches, and supports nominal generator pads sized about 36×48 inches and about 42×60 inches. Additional sizes may be introduced without altering the fundamental relationships between posts, cavities, rib networks, and sidewall geometry. The assembled pad (100) may present an overall height of about one inch, about two inches, or about three inches for representative offerings, with intermediate values also possible according to market needs. The overall height stated refers to the assembled pad (100) composed of the first unit (102) and the second unit (104). Multiple pads can be stacked during storage or transit to achieve increased total stack heights, where the total height equals the single pad height multiplied by the number of stacked pads. The stacking described refers to storage or transit contexts rather than stacked service use, thereby maintaining clear expectations for field deployment, although stacked service is possible. The described size and height families accommodate varying clearances, equipment masses, and service access preferences encountered in residential settings. The size and height families also allow distributors to stock a manageable set of standardized components while satisfying diverse field requests. The described approach maintains structural relationships across sizes to preserve manufacturing efficiency and consistent performance.

The connecting walls (146) and connecting walls (148) provide complementary reinforcement patterns. Each connecting wall (146) radiates from the central hub wall (142) toward a corner hub wall (140) to create a spoke-like pattern that establishes direct structural continuity between the center and each corner. Each connecting wall (148) extends between corner regions or corner hub walls (140) while contacting the central hub wall (142) and not contacting any corner hub wall (140), thereby keeping corner regions open internally. Each connecting wall (148) may terminate at a non-corner tubular cavity (150) that resides between corner regions and may cooperate with associated terminating walls (152) to reach the sidewall (110). The patterns formed by connecting walls (146) and connecting walls (148) can be or can avoid being co-aligned with supporting walls (144) enclosed by the central hub wall (142) to create uninterrupted linear load paths across the rib network. Co-alignment may increase stiffness and reduce deflections under concentrated equipment foot loads on the first base outer side (108OS). The patterns may be symmetrical for rectangular planforms or may be intentionally asymmetrical for planforms with unequal spans or for equipment with uneven weight distribution. The patterns may include localized thickening at intersections where multiple walls meet to handle complex stress fields during thermal cycling and dynamic loading. The described networks maintain access to the plurality of tubular cavities (114) and maintain clearances for the plurality of posts (126) to enter during assembly.

The corner hub walls (140) and the central hub wall (142) define fundamental differences between corner structure and central structure that the viewer can visualize clearly. Each corner hub wall (140) forms a shape that can resemble an arc, a partial loop, or a ring perimeter without enclosing internal partitions, thereby keeping the interior of the corner hub area open, whether hollow or solid. The lack of internal partitions within each corner hub wall (140) enables the description to maintain clear spaces near corners for optional features or for weight savings. The central hub wall (142) forms a closed perimeter around the central tubular cavity (122) and may surround supporting walls (144) arranged radially to connect the closed perimeter with the central cavity boundary. The presence of supporting walls (144) within the central hub wall (142) can enhance stiffness near the center where vertical loads and assembly forces can create concentrated stresses. The central hub wall (142) may include apertures or internal coring to reduce mass while maintaining necessary enclosure around the central tubular cavity (122). The distinction between open corner hubs and enclosed central hubs supports the different roles played by corners and the center during load transfer and alignment. The corner regions prioritize open geometry and guided association with corner indents (156), while the center region prioritizes positive centering via the central post (132) and the central tubular cavity (122).

Handling features enhance installer ergonomics without constraining structural design or assembly sequences. The sidewall (110) may include shallow handhold recesses sized for gloved fingers, thereby allowing installers to grasp opposing sides during placement and flipping maneuvers. Larger size families may include optional forklift notches along edges of the second base (124), where each notch avoids interrupting the second base outer side (104OS) contact plane by using shallow rebated geometry on non-contacting faces. The first base outer side (108OS) may include a fine stipple or micro-rib texture that increases traction for equipment feet while concealing handling scuffs. The second base inner side (104IS) may include subtle textures that visually differentiate interior faces from exterior faces during staging without restricting performance. The label (154) may locate near a handhold recess to provide a visual cue regarding orientation prior to the skyward assembly step. The described features support flipping the assembled pad (100) from a skyward configuration to a ground-engaging configuration without impacting post-and-cavity engagement. The described features also encourage safe manual handling for small sizes and sensible mechanical handling for larger sizes. The described features maintain compatibility with the corner alignment logic supplied by the corner indents (156). The described features integrate into the broader geometry without implying limitations on other ergonomic improvements.

Installation narratives for new work and retrofit conditions remain consistent with the described geometry and assembly logic. Installers can prepare the ground (158) using grading and compaction practices appropriate for local conditions, which may include compacted aggregate layers, geotextile separators, or shaped beds to encourage drainage away from pad edges. Installers can place the first unit (102) on the staging surface with the first base inner side (108IS) facing upward to expose the plurality of tubular cavities (114) and rib clusters. Installers can align the second unit (104) above the first unit (102) and arrange the second unit (104) downward so that the corner indents (156) guide corner rib clusters before or during location of the corner tubular cavities (120) relative to the corner posts (130). Installers can continue lowering until the corner posts (130) and the central post (132) enter corresponding cavities and achieve desired engagement depth. Installers can flip the assembled pad (100) onto the ground (158) with the second base outer side (104OS) facing downward, thereby establishing broad ground contact. Installers can position the condenser (134) or the generator (136) on the first base outer side (108OS) using standard residential practices for equipment footprint alignment. Installers can verify level and perform minor shimming under the ground (158) or along perimeter edges if site conditions warrant incremental corrections. Installers can complete utility connections according to applicable standards without reliance on pad (100) modifications, thereby preserving pad structural integrity. The described narrative provides a practical sequence while recognizing permissible alternatives described above.

Environmental exposure considerations inform several optional enhancements that do not restrict the fundamental geometry. The first unit (102) and the second unit (104) can incorporate UV stabilizers and color packages that mitigate long-term fading or brittleness under sunlight exposure. The second base outside side (104OS) can maintain sufficient flatness under expected temperature ranges to preserve bearing integrity on ground (158). The plurality of ribs (112), hub walls (138), and connecting walls (146/148) can maintain adequate stiffness to resist creep under sustained loads from supported equipment. The corner alignment relationship between corner rib clusters and corner indents (156) can continue to function under seasonal expansion and contraction because each component remains free of high-constraint binding at corners. The first base outside side (108OS) can resist surface wear from equipment feet by presenting robust skin layers achieved through molding practices or material selection. The plurality of posts (126) and the plurality of tubular cavities (114) can maintain engagements through interference features, adhesive bonds, mechanical snaps, or combinations thereof to mitigate vibration-induced loosening. The pad (100) surfaces can be cleaned with common maintenance procedures without exposure to aggressive solvents that could affect polymer performance. The described environmental strategies complement the structural hierarchy without modifying core alignment and support relationships. The described considerations assure the viewer that the geometry functions across a realistic range of residential environments. The described considerations remain qualitative to preserve broad applicability.

Alternative planforms can introduce different numbers of corner hub walls (140) and corner tubular cavities (120), while the central hub wall (142) and central tubular cavity (122) remain conceptually central for indexing. Alternative rib densities can increase or decrease the number of connecting walls (146/148) and terminating walls (152) to tune stiffness for specific sizes or loads. Alternative post counts can add or remove non-corner posts (126) to match non-corner tubular cavities (150) patterns where installers desire enhanced anti-rotation behavior. Alternative retention strategies can substitute adhesives, snaps, quarter-turn locks, or through-bolts to address uplift or theft concerns across different jurisdictions. Alternative textures can adjust traction for equipment feet on the first base outer side (108OS) or adjust handling friction on side surfaces during staging. Alternative labels can present additional information in the label (154) panel without affecting structure or assembly. Alternative material choices, including polymer concrete or metal, can implement the described geometry for projects that favor different manufacturing ecosystems. Alternative heights for the assembled pad (100) can deviate from the representative one-inch, two-inch, or three-inch heights while maintaining the described ground-engaging and equipment-supporting planes.

In some situations, the pad may include optional fill material placed within one or more wells, cavities, or hub regions of the first unit (102) to further mitigate buoyancy and control settlement when installed on soft or saturated ground (158). The first unit (102) includes a network of ribs, hub walls, and wells that define internal spaces suitable for receiving fill material. These spaces may include the central well enclosed by the central hub wall (142), lateral wells adjacent to corner hub walls (140), and additional wells formed between connecting walls (146) and terminating walls (152).

The fill material may be selected to increase the overall mass of the pad, thereby reducing the risk of buoyancy in flood-prone or seasonally saturated environments. Suitable fill materials include sand, gravel, concrete, cementitious mixtures, superabsorbent polymer gels, or other pumpable or pourable substances that can be introduced into the wells during installation or manufacturing. In some situations, the fill material may be introduced on-site, for example, by pouring sand or gravel into the wells, or by injecting a gel or cementitious mixture that subsequently cures or hardens within the pad (100) structure.

The fill material may be selected to provide additional rigidity and load distribution, further minimizing settlement of the pad (100) under heavy equipment loads. For example, a gel fill may be used to absorb water and expand within the wells, while a concrete or cementitious fill may be used to create a hardened mass that resists deformation. In colder climates, the fill material may include antifreeze or other additives to lower the freezing point and prevent expansion or cracking due to freeze-thaw cycles.

The volume and type of fill material may be tailored to the specific installation environment and equipment requirements. For example, the fill may be introduced to achieve a target pad (100) weight, such as 100 pounds, 200 pounds, or 300 pounds, depending on the size of the pad (100) and the expected equipment load. The fill may be introduced into all available wells or selectively into central or corner wells as needed to achieve desired performance characteristics.

The pad (100) may be designed to facilitate introduction and containment of fill material, for example, by providing access ports, removable covers, or integrated channels that guide the fill into designated wells. After the fill material is introduced, the pad (100) may be allowed to cure or settle for a predetermined period before final placement and equipment installation. For example, the first unit (102) may rest until the fill material cures or solidifies and then the second unit (104) is arranged to engage with the first unit (102) as described above. The fill material may remain permanently within the pad (100) or may be removable or replaceable in some situations.

The use of optional fill within the first unit (102) provides additional flexibility for installers and end users, allowing the pad (100) to be adapted to a wide range of site conditions and equipment requirements. The fill material enhances the pad's (100) ability to resist buoyancy, minimize settlement, and maintain stable support for outdoor equipment over time.

The pad (100) described herein provides several technical advantages that address long-standing challenges in supporting outdoor HVAC condensers and standby electrical generators. By utilizing the pad (100) with a two-unit architecture—where the first unit (102) rests on the second unit (104), or vice versa, and is optionally secured by the plurality of posts (126) received in the plurality of tubular cavities (114)—the pad (100) achieves superior resistance to sinking and uneven settlement compared to conventional single-piece pads. The flat ground-contacting surface of the second unit (104), or the first unit (102), distributes load efficiently over soft or saturated soils, while the ribbed structure and the plurality of hub walls (138) of the first unit (102) enable effective load transfer and structural rigidity. Optional fill materials placed within wells of the first unit further enhance stability by increasing pad mass and mitigating buoyancy, especially in flood-prone or seasonally wet environments. The modular design allows for rapid installation, easier transport, and adaptability to a wide range of site conditions and equipment sizes. These features collectively result in improved code compliance for required minimum elevation, reduced maintenance due to settlement or misalignment, and greater long-term reliability of supported equipment. The combination of these technical solutions provides advantages that are not present in conventional pads, thereby overcoming conventional limitations and addressing the practical needs of installers and end users.

Although various examples have been depicted and described in detail herein, skilled persons know that various modifications, additions, substitutions and the like can be made without departing from this disclosure. As such, these modifications, additions, substitutions and like are considered to be within this disclosure

What is claimed is:

1. A method, comprising:
enabling a user to:
access a pad having a first unit and a second unit, wherein the first unit includes a container having a first base, a sidewall, and a plurality of ribs, wherein the sidewall extends away from the first base, wherein the plurality of ribs extends from the first base, wherein the sidewall encloses the plurality of ribs, wherein the plurality of ribs hosts a plurality of tubular cavities, wherein the second unit includes a second base and a plurality of posts;
arrange the first unit and the second unit such that the plurality of tubular cavities receive the plurality of posts and the first base opposes the second base; and
position a condenser or a generator on the first base or the second base.

2. The method of claim 1, wherein the condenser or the generator is positioned on the first base.

3. The method of claim 1, wherein the condenser or the generator is positioned on the second base.

4. The method of claim 1, wherein the plurality of posts is monolithic with the second base.

5. The method of claim 1, wherein the first base includes a plurality of first base corners, wherein the sidewall includes a plurality of sidewall corners, wherein the plurality of sidewall corners overlaps the plurality of first base corners, wherein the plurality of tubular cavities includes a plurality of corner tubular cavities respectively spaced apart from the plurality of first base corners and the plurality of sidewall corners, wherein the plurality of tubular cavities includes a central tubular cavity, wherein the second base includes a plurality of second base corners, wherein the plurality of posts includes a plurality of corner posts respectively spaced apart from the plurality of second base corners, wherein the plurality of posts includes a central post, wherein the first unit and the second unit are arranged such that the plurality of corner tubular cavities receive the plurality of corner posts, the central tubular cavity receives the central post, and the first base opposes the second base.

6. The method of claim 5, wherein the plurality of ribs includes a plurality of hub walls, wherein the plurality of hub walls includes a plurality of corner hub walls and a central hub wall, wherein the plurality of corner tubular cavities is positioned external to the plurality of corner hub walls such that the plurality of corner hub walls is respectively positioned between the plurality of corner tubular cavities and the central hub wall, wherein the central hub wall encloses the central tubular cavity.

7. The method of claim 6, wherein each hub wall of the plurality of corner hub walls does not enclose any walls.

8. The method of claim 6, wherein the central hub wall encloses a plurality of supporting walls radiating from the central tubular cavity such that the plurality of supporting walls respectively span between the central hub wall and the central tubular cavity.

9. The method of claim 8, wherein the plurality of ribs includes a plurality of connecting walls radiating from the central hub wall and respectively spanning between the central hub wall and the plurality of corner hub walls.

10. The method of claim 9, wherein the plurality of connecting walls is coaligned with the plurality of supporting walls.

11. The method of claim 9, wherein the plurality of ribs includes a plurality of connecting walls radiating from the central hub wall and extending between at least two corner hub walls of the plurality of corner hub walls, wherein the plurality of tubular cavities includes a plurality of non-corner tubular cavities, wherein at least two connecting walls of the plurality of connecting walls respectively terminate at the plurality of non-corner tubular cavities.

12. The method of claim 11, wherein the plurality of ribs includes a plurality of terminating walls respectively spanning between the plurality of non-corner tubular cavities and the sidewalls.

13. A method, comprising:
enabling a user to:
access a pad having a first unit and a second unit, wherein the first unit includes a container having a first base, a sidewall, and a plurality of ribs, wherein the sidewall extends away from the first base, wherein the plurality of ribs extends from the first base, wherein the sidewall encloses the plurality of ribs, wherein the plurality of ribs hosts a plurality of tubular cavities, wherein the first base includes a plurality of first base corners, wherein the sidewall includes a plurality of sidewall corners, wherein the plurality of sidewall corners overlaps the plurality of first base corners, wherein the plurality of tubular cavities includes a plurality of corner tubular cavities respectively spaced apart from the plurality of first base corners and the plurality of sidewall corners, wherein the plurality of tubular cavities includes a central tubular cavity, wherein the second unit includes a second base and a plurality of posts, wherein the second base includes a plurality of second base corners, wherein the plurality of posts includes a plurality of corner posts respectively spaced apart from the plurality of second base corners, wherein the plurality of posts includes a central post;
arrange the first unit and the second unit such that the plurality of corner tubular cavities receive the plurality of corner posts, the central tubular cavity receives the central post, and the first base opposes the second base; and
position a condenser or a generator on the first base or the second base.

14. The method of claim 13, wherein the condenser or the generator is positioned on the first base.

15. The method of claim 13, wherein the condenser or the generator is positioned on the second base.

16. The method of claim 13, wherein the plurality of ribs includes a plurality of hub walls, wherein the plurality of hub walls includes a plurality of corner hub walls and a central hub wall, wherein the plurality of corner tubular cavities is positioned external to the plurality of corner hub walls such that the plurality of corner hub walls is respectively positioned between the plurality of corner tubular cavities and the central hub wall, wherein the central hub wall encloses the central tubular cavity.

17. The method of claim 16, wherein each hub wall of the plurality of corner hub walls does not enclose any walls.

18. The method of claim 16, wherein the central hub wall encloses a plurality of supporting walls radiating from the central tubular cavity such that the plurality of supporting walls respectively span between the central hub wall and the central tubular cavity.

19. The method of claim 16, wherein the plurality of ribs includes a plurality of connecting walls radiating from the central hub wall and respectively spanning between the central hub wall and the plurality of corner hub walls.

20. The method of claim 19, wherein the plurality of connecting walls is coaligned with the plurality of supporting walls.

21. The method of claim 16, wherein the plurality of ribs includes a plurality of connecting walls radiating from the central hub wall and extending between at least two corner hub walls of the plurality of corner hub walls, wherein the plurality of tubular cavities includes a plurality of non-corner tubular cavities (150), wherein at least two connecting walls of the plurality of connecting walls respectively terminate at the plurality of non-corner tubular cavities.

22. The method of claim 21, wherein the plurality of ribs includes a plurality of terminating walls respectively spanning between the plurality of non-corner tubular cavities and the sidewall.

23. The method of claim 13, wherein the plurality of first base corners, the plurality of sidewall corners, or the plurality of second base corners is four or less.

24. The method of claim 13, wherein the plurality of posts is monolithic with the second base.

25. A method, comprising:
enabling a user to:
access a pad having a first unit and a second unit, wherein the first unit includes a first base and a sidewall, wherein the sidewall extends away from the first base, wherein the second unit includes a second base and a plurality of ribs, wherein the plurality of ribs extends from the second base;
arrange the first unit and the second unit such that the sidewall encloses the plurality of ribs and the first base opposes the second base; and
position a condenser or a generator on the first base or the second base.
